(19) United States
(12) Patent Application Publication
(10) Pub. No.: US 2021/0129089 A1
(43) Pub. Date: May 6, 2021

(54) SUPER-HYDROPHILIC MEMBRANES BASED ON COPPER(I) IODIDE DEPOSITS ON METAL MESHES

(71) Applicants: YPF TECNOLOGÍA S.A., Ciudad Autónoma de Buenos Aires (AR); CONSEJO NACIONAL DE INVESTIGACIONES CIENTÍFICAS Y TÉCNICAS (CONICET), Ciudad Autónoma de Buenos Aires (AR); UNIVERSIDAD DE BUENOS AIRES, Ciudad Autónoma de Buenos Aires (AR)

(72) Inventors: Norma Beatriz D'ACCORSO, Ciudad Autónoma de Buenos Aires (AR); Ricardo Martín NEGRI, Ciudad Autónoma de Buenos Aires (AR); Graciela ROJAS, Avellaneda (AR); Gabriel LOMBARDO, Ituzaingó (AR); Jorge Nicolás CABRERA, Ciudad Autónoma de Buenos Aires (AR); María del Mar CAMMARATA, Ciudad Autónoma de Buenos Aires (AR)

(21) Appl. No.: 17/083,807

(22) Filed: Oct. 29, 2020

Related U.S. Application Data
(60) Provisional application No. 62/929,454, filed on Nov. 1, 2019.

(51) Int. Cl. B01D 71/02; B01D 69/02; B01D 67/00; C02F 1/44

(52) U.S. Cl. CPC B01D 71/022; B01D 69/02; B01D 67/0069; B01D 67/0095; C02F 2101/32; B01D 2325/36; B01D 2325/02; B01D 2323/02; C02F 1/44

(57) ABSTRACT

A super-hydrophilic membrane comprising a metal mesh comprising copper and a coating comprising copper(I) iodide crystals and a method of preparation thereof are disclosed. The membranes provided by the invention have improved physical properties, such as super-hydrophilicity as well as underwater oleophobicity, and are specifically adapted for oil/water separation processes.

### CROSS REFERENCE TO RELATED APPLICATIONS

This application claims priority of U.S. Provisional Application No. 62/929,454 filed on Nov. 1, 2019 under 35 U.S.C. § 119(e), the entire contents of which are hereby incorporated by reference.

### FIELD OF THE INVENTION

The present invention refers to super-hydrophilic membranes for oil/water separation having improved physical properties, such as super-hydrophilicity as well as underwater oleophobicity, and to methods of preparation thereof.

### BACKGROUND OF THE INVENTION

Membrane separation processes are widely used in the treatment of oily wastewater, due to the high separation efficiency and their relatively easy operation and control.

The oil industry typically requires large amounts of water in order to extract oil, both in conventional and non-conventional processes, such as fracking. As a result, large mixtures of oil and water are obtained, which must be separated to recover crude oil. Membranes allowing separation of an aqueous and an oily phase are traditionally employed to this end.

Super-hydrophilic membranes have an increased affinity towards water and repel organic substances. Their use in the oil industry would allow reducing treatment times. However, super-hydrophilic properties are usually obtained by using complex chemical compounds, such as chemically modified polymers or nanoparticles such as zeolites, resulting in costly methods of manufacture. In addition, these membranes tend to be easily fouled by deposition of organic substances, which decreases their durability and their potential to be used in several separation cycles.

Patent application WO 2009/39467 describes composite membranes for removing contaminants from water. The membranes comprise a water-permeable thin film polymerized on a porous support membrane.

US Patent application No. 2015/014243 describes oil/water separation membranes and their uses. The super-hydrophilic membranes comprise a porous substrate, such as a copper mesh and a molecular sieve coating such as a nano-zeolite.

US Patent application No. 2014/319044 describes membranes functionalized with nanoparticles, wherein the nanoparticles closest to the membrane surface are covalently bonded to the membrane surface.

US Patent application No. 2014/209534 describes oil/water separation filters having zwitterionic polymers grafted onto a membrane surface.

As previously mentioned, the super-hydrophilic membranes for oil/water separation of the prior art are obtained from relatively expensive materials or require a combination of chemical substances for adequate separation.

There is therefore a need to provide membranes with improved super-hydrophilicity properties, obtained from low cost materials, and that result in more efficient oil/water separation processes.

### BRIEF DESCRIPTION OF THE INVENTION

The present invention is based on the unexpected super-hydrophilicity properties obtained by treating a porous substrate, such as a porous metal mesh comprising coper, with an iodine solution. Copper(I) iodide (CuI) crystals coat the mesh surface, forming a super-hydrophilic membrane that also presents super-oleophobicity in water.

Therefore, in a first aspect, the present invention provides a super-hydrophilic membrane consisting of a metallic mesh comprising a copper iodide coating.

More specifically, the present invention provides a super-hydrophilic membrane comprising

a porous substrate comprising a metal mesh; and

a coating comprising copper(I) iodide crystals.

In a preferred embodiment, the atomic ratio of copper to iodine is of approximately 1. The copper(I) iodide crystals in the coating form micro-nanoparticles with approximate tetrahedral shape.

In a preferred embodiment, the metal mesh comprising copper is a metal mesh selected from the group consisting of a copper metal mesh, a brass metal mesh and a bronze metal mesh.

In another preferred embodiment, the metal mesh has a pore size of 50-100 μm. Preferably, the metal mesh has a pore size of 77 μm.

Preferably, the coating is obtained by immersion into a solution containing iodine or by spraying of a solution containing iodine onto the surface of the metal mesh.

In a second aspect, the present invention provides a method for preparing a super-hydrophobic membrane comprising the steps of:
a) providing a metal mesh comprising copper;
b) cleaning the metal mesh by immersion in a solvent;
c) treating the metal mesh cleaned in step b) with a solution comprising iodine, thereby forming CuI crystals on a surface of the metal mesh;
d) drying the metal mesh treated in step c) in order to obtain the super-hydrophilic membrane.

In a preferred embodiment, the step c) of treating the metal mesh is carried out by immersion into the solution comprising iodine. Preferably, the immersion time is 1 between 1 second and 60 seconds. More preferably, the immersion time is 1 second.

In another preferred embodiment, the step c) of treating the metal mesh is carried out by spraying of the solution comprising iodine onto a surface of the metal mesh.

In yet another preferred embodiment, the solution comprising iodine is a solution of iodine in ethanol at a concentration between 0.05 and 0.5 mol/L. Preferably, the concentration is approximately 0.1 mol/L.

In a preferred embodiment of the method of the present invention. the steps c) and d) are repeated. Preferably, the steps c) and d) are repeated a number of times from 1 to 20. Preferably, the steps are repeated 1, 2, 3, 4, 5, 6, 7, 8, 9, 10, 11, 12, 13, 14, 15, 16, 17, 18, 19 or 20 times. Even more preferably, the steps are repeated 1, 5, 10 or 15 times.

In a further preferred embodiment, in step b) the solvent is selected from the group consisting of de-ionized water, ethanol, a diluted solution of hydrochloric acid or mixtures thereof.

In yet another preferred embodiment, wherein the step d) of drying the metal mesh is carried out in an air atmosphere at room temperature.

In a further preferred embodiment, the step d) of drying the metal mesh is carried out in a stove under vacuum conditions.

### BRIEF DESCRIPTION OF THE FIGURES

FIG. 1 shows the EDS analysis of the CuI membranes.

FIG. 2 shows SEM images of the CuI membranes obtained after different number of immersion cycles. FIGS. e,f,g and h: magnifications of a,b,c and d, respectively. It is observed in FIG. 2 that a larger amount of copper iodide was obtained after repeating the immersion cycles in the iodine solution (FIGS. 2a-b-c-d). CuI micro-nanoparticles with approximate tetrahedral shape were obtained (FIGS. 2e-f-g-h).

FIG. 3 shows (a), (b) and (c): super-hydrophilic behaviour of CuI membranes after 15 cycles: water drops completely spreads over the surface once in contact with the membrane. (d): underwater super-oleophobic behaviour for a chloroform drop immersed in water.

FIG. 4 shows the critical height of sunflower oil for CuI membranes on brass meshes of 77 μm pore, as function of the immersion cycles.

FIG. 5 is a photograph illustrating the separation capacity of a CuI membrane obtained after 15 cycles.

FIG. 6 shows the residual concentrations of toluene in water for CuI membranes determined by UV spectroscopy. The green line represents solubility of toluene in water at 25° C.

FIG. 7 shows the water flux through a CuI membrane for a height of water column of 5 cm.

FIG. 8 shows a SEM detail of the CuI membrane of Example 2.

FIG. 9 shows SEM images of CuI membranes of Example 3 prepared by spraying using a brass mesh of 77 μm pore.

FIG. 10 shows a magnified view of the SEM images of FIG. 9.

### DETAILED DESCRIPTION

The invention will be described in detail with reference to the accompanying figures.

The term “membrane” as used herein refers to a product or device acting as a selective barrier and useful in separation processes, such as an oil/water separation process. The term includes products obtained by coating and modifying a substrate or support, such as a metal mesh, as will be described in further detail below.

As used herein, the given numerical ranges of variables or physical quantities are intended to comprise the end values of the range as well as any intermediate values. The term “approximately” indicates that a given variable or physical quantity may be within a range of +/−10% of the given numerical value. The terms “oil”, “oily phase”, “organic substances” and equivalents are used in the present application indistinctly in order to indicate any hydrocarbon phase to be separated from a mixture with an aqueous phase. The acronyms SEM and EDS refer to, respectively to “scanning electron microscopy” and “energy dispersive spectroscopy”.

Generally, super-hydrophilic membranes based on formation of CuI crystals on copper or brass meshes were prepared. The crystals were formed by contacting the metallic meshes containing copper (Cu) with a liquid solution of iodine (I₂). The crystals are formed by oxidation of Cu by I₂, forming CuI crystals. This compound is known for being insoluble in water.

It was found that the presence of CuI crystals in the metal mesh provides unexpected super-hydrophilicity as well as underwater super-oleophobicity properties to the membrane, as illustrated by the air-water and chloroform underwater contact angles. In addition, the membranes present an increased water flux, in the range of 70-170 L/m²s.

The treatment of the mesh with a solution comprising iodine, such as an aqueous iodine (I₂) solution, can be carried out by immersion into the solution, or by spraying of the solution onto the mesh surface. After drying at room temperature, the immersion or spraying may be repeated several times. It was found that the water contact angle decreases with the number of repetitions.

Further, it was found that immersion time determines the water flux at a given 12 concentration in the solution. Larger crystals are obtained with the spraying method compared to those obtained with the immersion method, with both membranes presenting a similar water flux.

The drying of the membrane can be carried out at room temperature or using a low temperature stove under vacuum conditions, to obtain a lower drying time.

The membranes and methods of the present invention require typically inexpensive materials, and do not require monomers, polymerization initiators, zeolites or other chemical compounds, such as the membranes of the prior art.

The super-hydrophilic membranes and their methods of preparation will be illustrated below by means of non-limiting examples.

### Example 1: CuI Membranes Prepared by Immersion During 1 Second

### Preparation of Copper Iodide (CuI) Membranes

The metallic meshes were washed with acetone and de-ionized water, ethanol and a diluted solution of hydrochloric acid prior its use.

Then, washed brass meshes were immersed in an iodine solution in ethanol (98%) at 0.1 mol/L, and then dried in air at room temperature. The immersion time was around 1 second in all cases of Example 1.

The immersion was repeated a given amount of cycles.

Preparations using 1, 5, 10 and 15 cycles were tested. Membranes remained underwater at room temperature for further testing.

### Materials

All solvents and reagents were of analytical quality and were used as received. Iodine (I₂) was purchased from Biopack. Sunflower oil was purchased from a local store. Brass meshes were provided by Sueiro & Hijos (Ciudadela, Provincia de Buenos Aires, Argentina). The porous diameter of the meshes used in the present example was 77 μm, as determined by SEM. The Cu/Zn ratio was approximately 4, determined by EDS. These meshes are typically used in several oil-water separation processes at industrial levels.

### Membrane Characterization

Atomic percentages of Cu, I and Zn on the membranes were determined by EDS, as shown in FIG. 1 and Table I.

TABLE I
Atomic percentages of Zn, Cu, I in the membranes. The amount
of zinc (Zn) is attributed to the presence of zinc in the
metallic substrate (mesh), under the CuI deposit.

| Element | Atomic % |
|---|---|
| Zn | 2 |
| Cu | 35 |
| I | 30 |

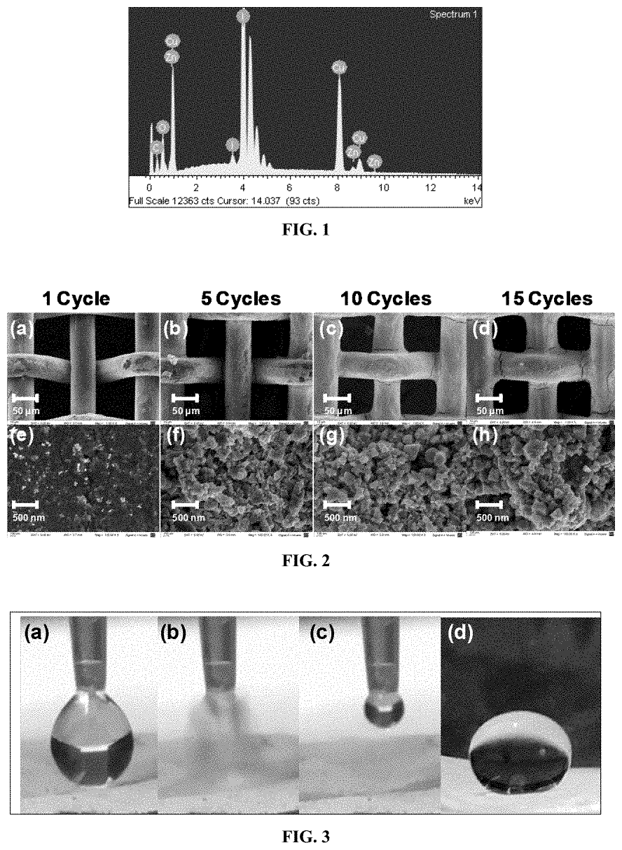

Table I shows that the ratio Cu/I is of approximately 1. The amount of copper is slightly larger than iodine due to brass substrate contribution. This is in agreement with the proposed stoichiometry (CuI), wherein copper ions are present as Cu(I). It is reported that, at room temperature, the main oxidation state for copper in copper iodide is Cu(I) (Zhop et al, Materials Letters 60 (2006) 2184-2186). FIG. 2 shows SEM images of the membranes.

### Water in Air and Chloroform Underwater Contact Angle

Water in air contact angles (WA-CA) and chloroform (oil) underwater contact angles (OW-CA) were determined using a smartphone camera and analyzing images with an Image J plugin. Contact angles were determined by analyzing three drops on each membrane, and on three different replicated membranes. For each type of membrane prepared, a total of 9 values were obtained, which were averaged. Table II shows water in air (WA-CA) and chloroform underwater (CUW-CA) contact angles.

TABLE II
Contact angles of the studied surfaces.

| | | Water in air | Underwater |
|---|---|---|---|
| | | contact angle | contact angle |
| Membrane | Cycles | (WA-CA) | (OW-CA) (cloroform) |
| Uncoated Mesh | 0 | 131° ± 5° | 113° ± 10° |
| CuI | 1 | 62° ± 10° | 155°-165° |
| membrane | 5 | 34° ± 10° | 155°-165° |
| | 10 | 10° ± 5° | 155°-165° |
| | 15 | <50 | 155°-165° |

The membranes also show super-hydrophilicity and underwater super-oleophobicity after 15 cycles. A water drop deposited on the membrane completely spreads over the surface, while the chloroform drop easily slides over it underwater, as shown in FIG. 3.

### Critical Height Measurements

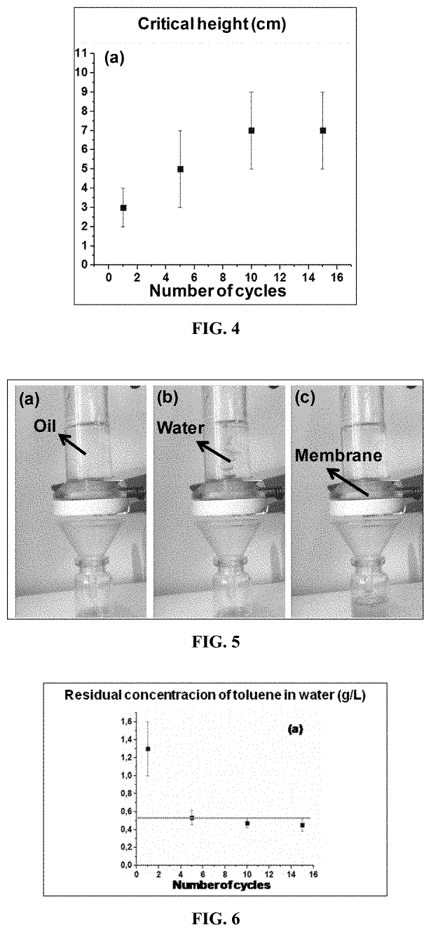

Using an appropriate container, sunflower oil was added on top of the treated membrane. The height of the oil-column when oil starts filtering through the membrane is currently defined as the critical height of the membrane. This parameter was determined for three replicates of each membrane. FIG. 4 shows the increase of critical height with the number of cycles.

### Oil Water Separation Efficiency

Oil water separation efficiency was estimated by the amount of residual toluene in water after separating a mixture of toluene and water with the prepared membrane. Mixtures consisted of 3 mL of toluene and 3 mL of distilled water. This mixture was vigorously shaken and then poured on top of the membrane. Then, the aqueous phase was collected. The amount of toluene in the collected phase was determined by a chloroform extraction of toluene and followed by Ultraviolet absorption of the extracted phase.

Examples of separation qualities are illustrated in FIGS. 5 and 6.

### Water Flux Measurement

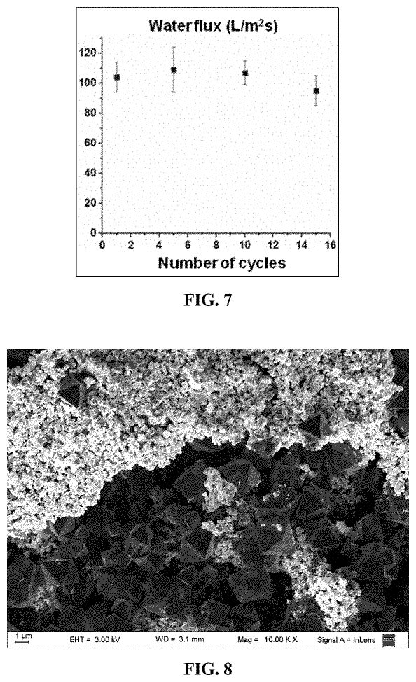

Water flux through the membrane was determined by measuring the volume of water collected through the membrane during a predetermined time, typically 40-50 seconds, maintaining a constant water column height of 5 cm (FIG. 7).

### Example 2: CuI Membranes Prepared by Immersion During 30 Seconds

In this example, the meshes were immersed during 30 seconds, instead of 1 second as in Example 1. That is, each immersion cycle lasts for 30 seconds. All other experimental conditions were identical to those of Example 1.

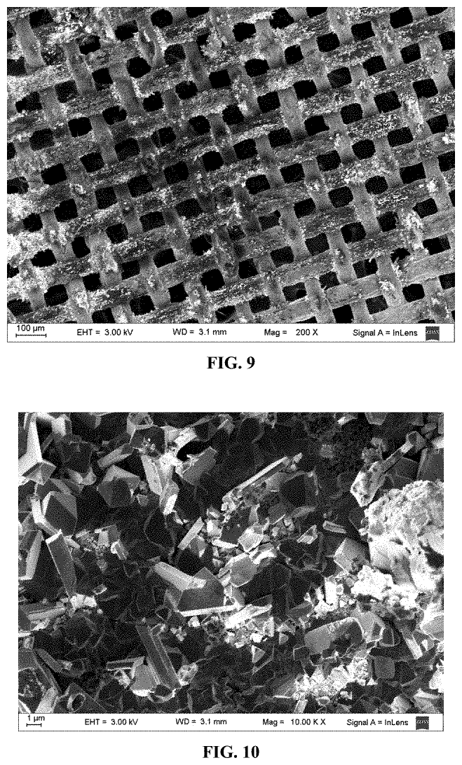

FIG. 8 shows SEM images for a membrane prepared with 15 cycles of 30 seconds each. A bi-modal distribution of crystal sizes was observed. The flux obtained for the membrane shown in FIG. 8 was 7 L/m²s, i.e. one order of magnitude lower than in case of Example 1. These results show that immersion time determines the water flux (at a given 12 concentration).

### Example 3: CuI Membranes Prepared by Spray Methods

CuI membranes were prepared by spraying a solution of I₂ in ethanol towards a brass or copper mesh. Concentration of I₂ in the ethanol solution was 0.1 mol/L. Brass meshes with pores of 77 μm as en Examples 1 and 2 were employed.

In Example 3, larger crystals were obtained in comparison with those using the immersion method (see FIG. 10 and compare with FIG. 2h). In this example, the water flux was approximately 170 L/m²s, in the order of magnitude of Example 1, or slightly larger.

It is to be understood that the above description is intended to be illustrative and not restrictive. Many embodiments will be apparent to those skilled in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

1. A membrane comprising:
a metal mesh comprising copper; and
a coating comprising copper(I) iodide crystals.

2. The membrane according to claim 1, wherein the atomic ratio of copper to iodine is of approximately 1.

3. The membrane according to claim 2, wherein the copper(I) iodide crystals form micro-nanoparticles with approximate tetrahedral shape.

4. The membrane according to claim 1, wherein the coating is obtained by immersion into a solution containing iodine or by spraying of a solution containing iodine onto the surface of the metal mesh.

5. The membrane according to claim 1, wherein the metal mesh has a pore size of 50-100 μm.

6. A method for preparing a membrane comprising the steps of:
a) providing a metal mesh comprising copper;
b) cleaning the metal mesh by immersion in a solvent;
c) treating the metal mesh cleaned in step b) with a solution comprising iodine, thereby forming copper(I) iodide crystals on a surface of the metal mesh;
d) drying the metal mesh treated in step c) in order to obtain the super-hydrophilic membrane.

7. The method according to claim 6, wherein the step c) of treating the metal mesh is carried out by immersion into the solution comprising iodine.

8. The method according to claim 7, wherein the immersion time is in the range between 1 second and 60 seconds.

9. The method according to claim 6, wherein the step c) of treating the metal mesh is carried out by spraying of the solution comprising iodine onto a surface of the metal mesh.

10. The method according to claim 6, wherein the solution comprising iodine is a solution of iodine in ethanol at a concentration between 0.05 and 0.5 mol/L.

11. The method according to claim 6, wherein the steps c) and d) are repeated.

12. The method according to claim 11, wherein the steps c) and d) are repeated a number of times between 1 and 20.

13. The method according to claim 6, wherein the metal mesh has a pore size of 50-100 μm.

14. The method according to claim 13, wherein the metal mesh has a pore size of 77 μm.

15. The method according to claim 6, wherein the metal mesh comprising copper is a metal mesh selected from the group consisting of a copper metal mesh, a brass metal mesh and a bronze metal mesh.

16. The method according to claim 6, wherein in step b) the solvent is selected from the group consisting of de-ionized water, ethanol, a diluted solution of hydrochloric acid or mixtures thereof.

17. The method according to claim 6, wherein the step d) of drying the metal mesh is carried out in an air atmosphere at room temperature.
